(19) United States
(12) Patent Application Publication
(10) Pub. No.: US 2007/0084692 A1
(43) Pub. Date: Apr. 19, 2007

(54) Clutch device for an automobile transmission, in particular for a form-locking and a frictionally-engaging clutch

(76) Inventors: Roland Fischer, Oberteuringen (DE); Gerhard Buck, Friedrichshafen (DE); Martin Reck, Hohentengen (DE)

Correspondence Address: DAVIS & BUJOLD, P.L.L.C., 112 PLEASANT STREET, CONCORD, NH, 03301, US

(21) Appl. No.: 11/400,981

(22) Filed: Apr. 10, 2006

(30) Foreign Application Priority Data
Apr. 11, 2005 (DE) 102005016494.3

(51) Int. Cl. F16D 11/00

(52) U.S. Cl. 192/53.34

(57) ABSTRACT

A form-locking clutch (2) for an automobile transmission, in particular for a clutch device formed by a form-locking coupling and the disc clutch (2), having a piston (6) connected to a drive or in a torque proof piston manner to a drive, is connectable to an external disc carrier (3) of the disc clutch via the form-locking clutch (2) constructed as a coupling disc, which encompasses a synchronizing ring (1), whereby at least one guide pin (4) connected with the external disc carrier (3) of the disc clutch is provided, which can move along a connecting link (5) provided on the synchronizing disc (1) of the form-locking clutch (2) in such a way that, with a torque proof connection of the external disc carrier (3) to the piston (6) and for the case of a tooth on tooth position of the components, they can rotate so that the coupling disc engages.

This application claims priority from German Application Serial No. 10 2005 016 494.3 filed Apr. 11, 2005.

### FIELD OF THE INVENTION

The present invention relates to a form-locking clutch for an automobile transmission, especially for a clutch gear, including a form-locking clutch and a frictional clutch, which connects or separates an actuation from an output, whereas the form-locking clutch is activated in terms of disengaged and engaged and the frictionally-engaging clutch can be completely separated from the drive in the disengaged condition of the form-locking clutch.

### BACKGROUND OF THE INVENTION

In disc clutches or disc brakes customarily used in automatic transmissions, a high torque is also necessary in the disengaged condition for rotation with a rotational speed difference, since the discs also produce a drag torque due to lubrication located between the discs and, therefore, produce an equivalent drag loss.

According to the current state of technology, in order to reduce the drag moment which appears, the disengaged disc clutch is completely separated in the disengaged condition by a form-locking clutch so that discs in the disengaged condition manifest the same rotational speed.

It is known from the current state of technology how to use a form-locking clutch built from a coupling discs which is connectable by a disc spring to the external disc carrier. In the process, it may thereby be disadvantageous that teeth rest on teeth of the coupling disc, whereby torque is produced through the force of the disc spring, which prevents the teeth from moving with respect to each other, in order to be able to engage in gap between the teeth. As a consequence thereof, the coupling disc is tensioned tooth by tooth.

The present invention has the goal of providing for a form-locking clutch for the transmission of an automobile, in particular for a coupling device encompassing a form-locking clutch and a frictionally-engaging clutch in which tooth on tooth positioning is avoided and thus a deformation of the form-locking clutch is also prevented. A further goal of the invention is to reduce the overall length of the coupling device.

### SUMMARY OF THE INVENTION

According to this invention, a form-locking clutch for the transmission of an automobile is proposed. In particular, a clutch device encompassing a form-locking clutch and a frictionally-engaging clutch in which a piston connected with a drive, or in a torque-proof manner with a drive, which includes a synchronizing ring, is connectable with the external disc carrier of the disc coupling, whereby at least one guide pin connected with the external disc carrier of the disc coupling is provided that is movable along a connecting link provided on the synchronizing ring of the form-locking clutch in such a way that with a torque-proof connection of the external disc carrier to the piston and the case of a tooth on tooth positioning of the component parts, it may turn in such a way that the coupling disc engages.

According to an especially advantageous embodiment of the invention, an overall length reduction is achieved, if the connecting link for the guide pin is dimensioned in such a way that the initial position of the tooth tips of the lock gearing of the synchronizing ring and of the external disc carrier do not face each other, but instead the tooth flanks rest against each other. As a result, the overall length of the coupling is reduced by two times the height of a tooth.

### BRIEF DESCRIPTION OF THE DRAWINGS

The invention will now be described, by way of example, with reference to the accompanying drawings in which:

FIG. 1 is a schematic sectional view of the form-locking clutch according to the invention in the engaged position;

FIG. 2 is a schematic sectional view of the form-locking clutch according to the invention in a disengaged position;

FIG. 3-10 are schematic views (each with a sectional view and a top view) of the relative position of external disc carriers, the synchronizing ring and the piston for different phases of the clutch activation, which show the function of the form-locking clutch according to the invention, and

FIGS. 11 and 12 are perspective schematic views of the invention's synchronizing ring.

### DETAILED DESCRIPTION OF THE INVENTION

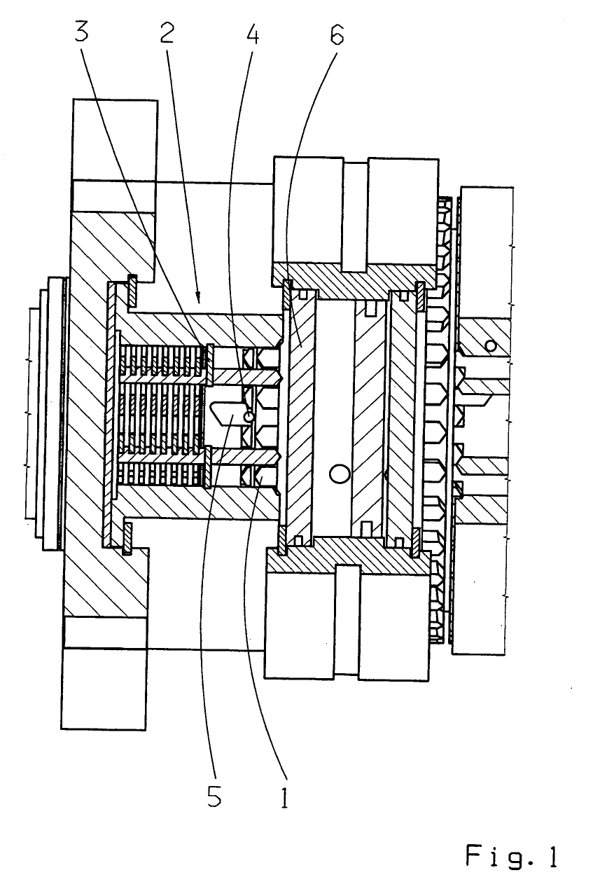

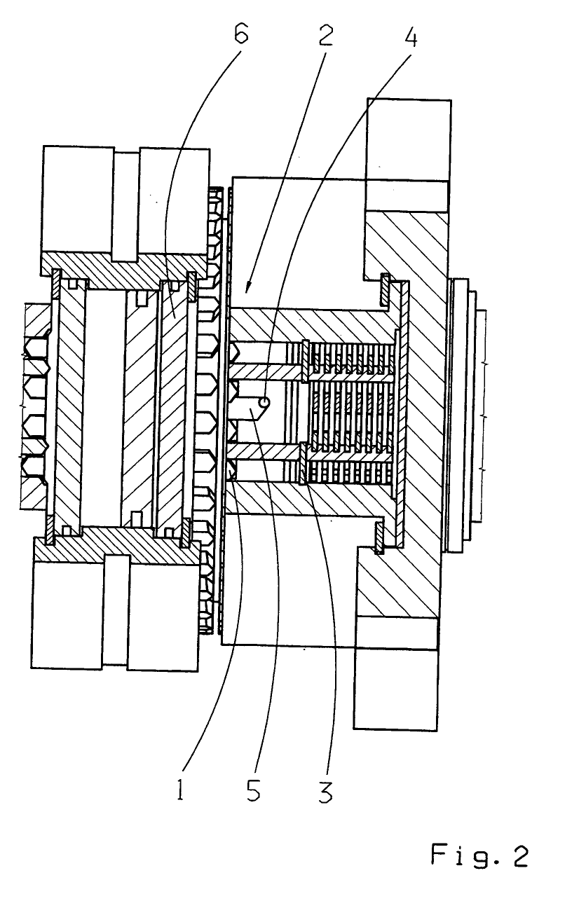

According to the invention and referring to FIGS. 1 and 2, a guide pin 4 connected with an external disc carrier 3 of the disc clutch, which is movable along a given connecting link 5 on a synchronizing disc 1 of a form-locking clutch 2 is provided to facilitate rotation of the components of the form-locking clutch 2 encompassing the synchronizing ring 1 to each other in the case of tooth on tooth positioning. In this embodiment, a piston 6 connected in a torque-proof manner with the drive is connected in a torque-proof manner with the external disc carrier 3. In FIG. 1, the form-locking clutch 2 is shown in the engaged position and, in FIG. 2, it is shown in disengaged position.

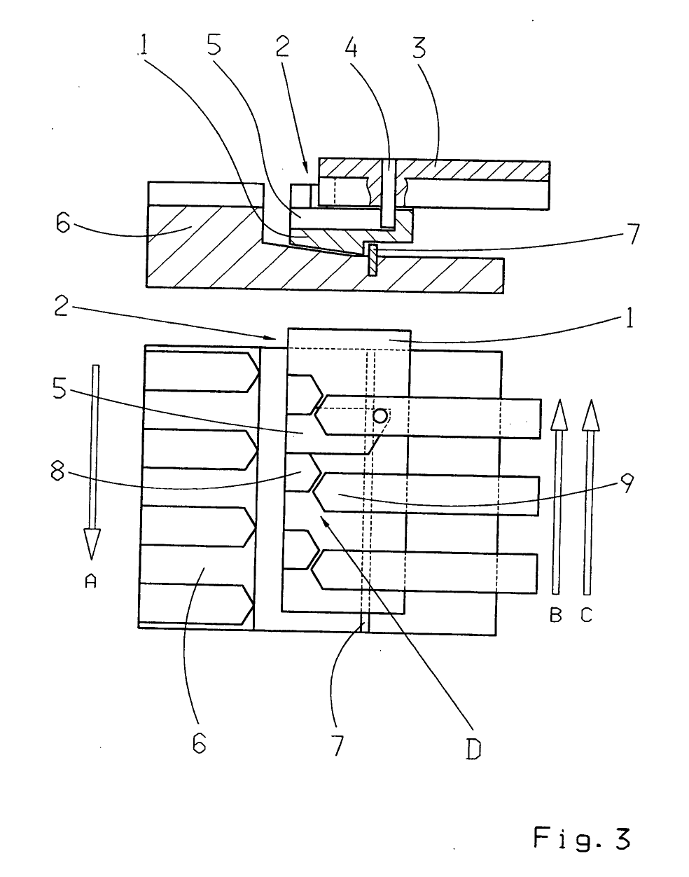

In FIG. 3, the initial condition of the form-locking clutch 2, before closing, is explained. The arrows show the direction of each of the components' movement. Arrow A indicates the radial movement of piston 6; arrow B the radial movement of the synchronizing disc 1, and arrow C the radial movement of the external disc carrier 3. As is obvious from this Figure, the rotational direction of piston 6, in this phase, is opposite to the direction of rotation of the external disc carrier 3 and of the synchronizing ring 1. Via the guide pin 4, placed in the connecting link 5 on the synchronizing ring 1 and connected to external disc carrier 3, rubbing of the synchronizing ring 1 on the friction surface of the piston 6 is prevented. Rubbing of the synchronizing ring 1 on an end plate 7 of the piston 6 is possible; however, this happens without force. According to the invention as shown in the Figure, the end plate 7, which is provided for the side of the synchronizing ring 1 facing away from the piston 6, is positioned, when viewed radially, below the synchronizing ring 1, whereby the overall length is reduced.

Furthermore, the locking gear is inclined on both sides resulting in the overall length reduction, which results in a smaller axial travel path for the components.

Due to guiding of guide pin 4 into the connecting link 5 and the drag moment between the synchronizing ring and the piston, the need for synchronization is obviated; the external disc carrier 3 and the synchronization ring 1 are, therefore, radially aligned with each other for the blocking position. The lock gearing of synchronizing ring 1 and of the external disc carrier 3 of the frictionally-engaging clutch are respectively designated as 8 and 9. The overall length reduction, according to the inventive method, is shown by arrow D; the initial position of the tooth tips of lock gearings 8 and 9 of synchronizing ring 1 and of external disc carrier 3 are located in such a way that the tooth flanks are positioned next to each other. For this purpose, the connecting link 5 of guide pin 4 is dimensioned so that relative movement of the external disc carrier 3 and the synchronizing ring 1 is prevented, which would result in a larger space between the two components. Therefore, the overall length of the entire clutch is advantageously reduced by two times the height of a tooth.

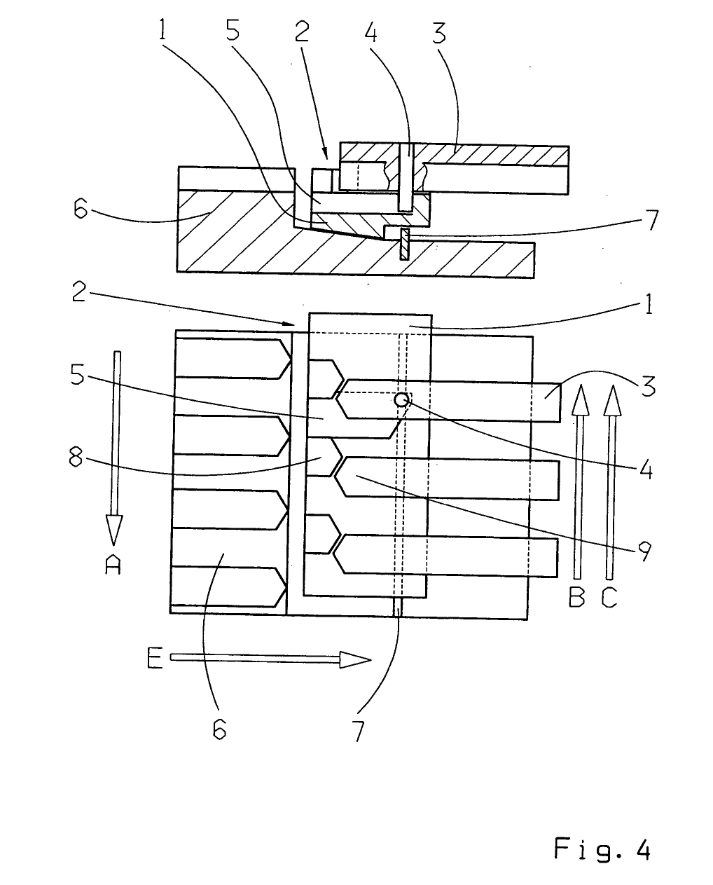

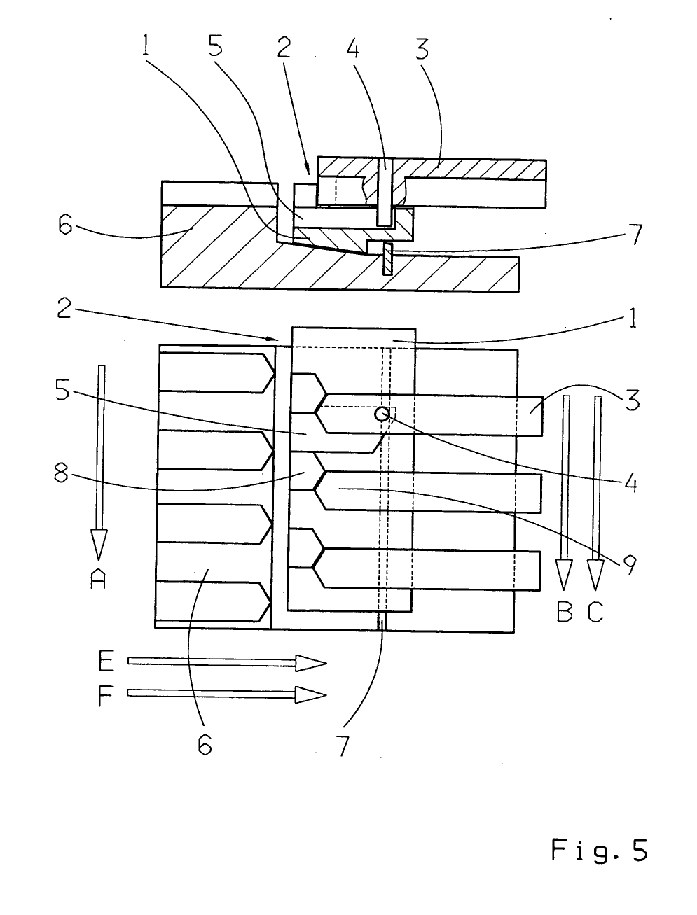

FIG. 4 shows the transition into the engaged position whereby piston 6 is pushed against synchronizing ring 1, as indicated by arrow E. The engaged position is the object of FIG. 5. In the engaged state, the lock gearings 8 and 9 are biased together and a frictional torque builds up between the piston 6 and the external disc carrier 3 (the axial movement of synchronizing ring 1 is indicated by arrow F in the Figure). Furthermore, the rotational speed difference between the piston 6, the external disc carrier 3 and the synchronizing ring 1 is reduced so that no rotational speed difference is present between piston 6 and synchronizing ring 1 in the engaged position. After a synchronized rotational speed is achieved, the frictional torque between piston 6 and external disc carrier 3 returns back to zero.

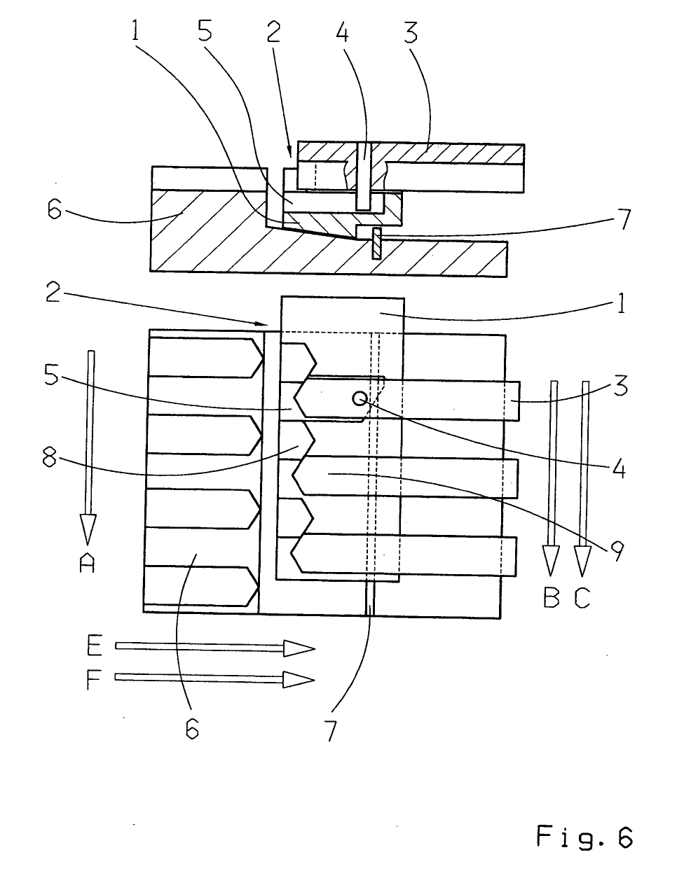

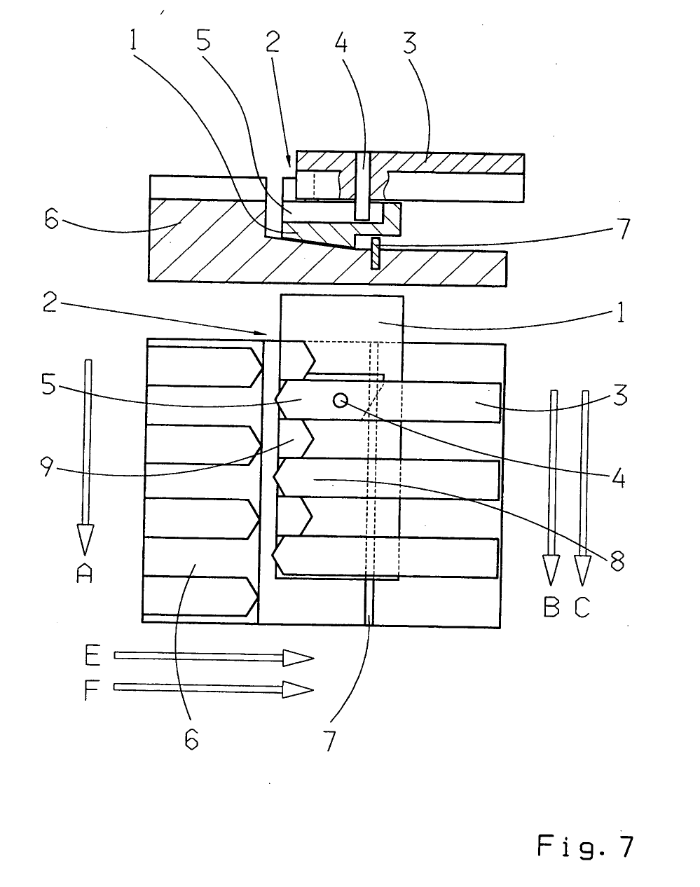

With an unblocking by means of a frictional torque interruption, the piston 6 and the synchronizing ring 1 are moved further axially in the direction of the external disc carrier 3. The synchronizing ring rotates by sliding of the lock gearing. This phase is the object of FIG. 6; FIG. 7 depicts the free flight phase in which the piston is pushed farther in the direction of the external disc carrier 3 so that the lock gearing 8, of the synchronizing ring 1, is guided between the gearing gaps of the external disc carrier 3. As a result, a rotational speed difference between the piston 6, the external disc carrier 3 and the synchronizing ring 1 is produced by the drag moment between the discs, which is caused by the external disc carrier and the idle wheel running in opposite directions to each other.

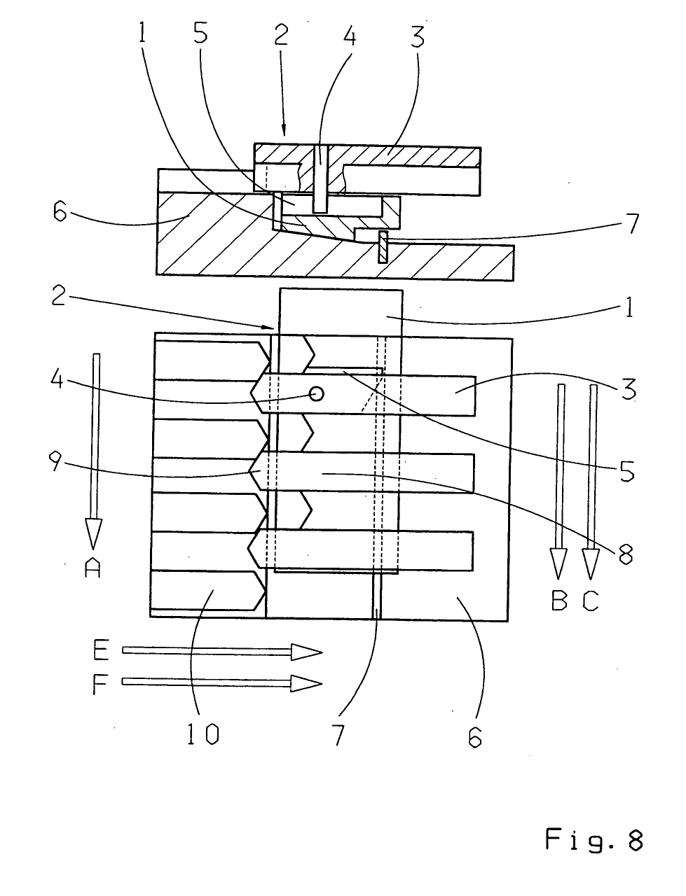

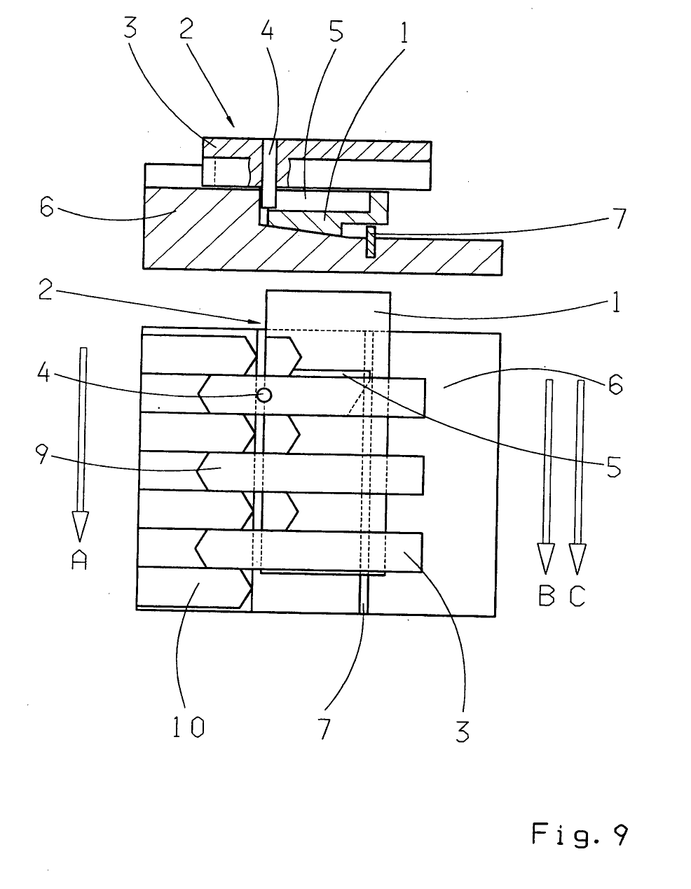

Further axial movement of piston 6, toward the direction of the external disc carrier 3, results in meshing of a gearing 10 of the piston 6 into the gearing gaps of the external disc carrier 3, as shown in FIG. 8. Radial rotation of the external disc carrier 3 is possible when the inclined frontal gearing areas abut against one another. The active condition of the form-locking clutch 2 is depicted in FIG. 9.

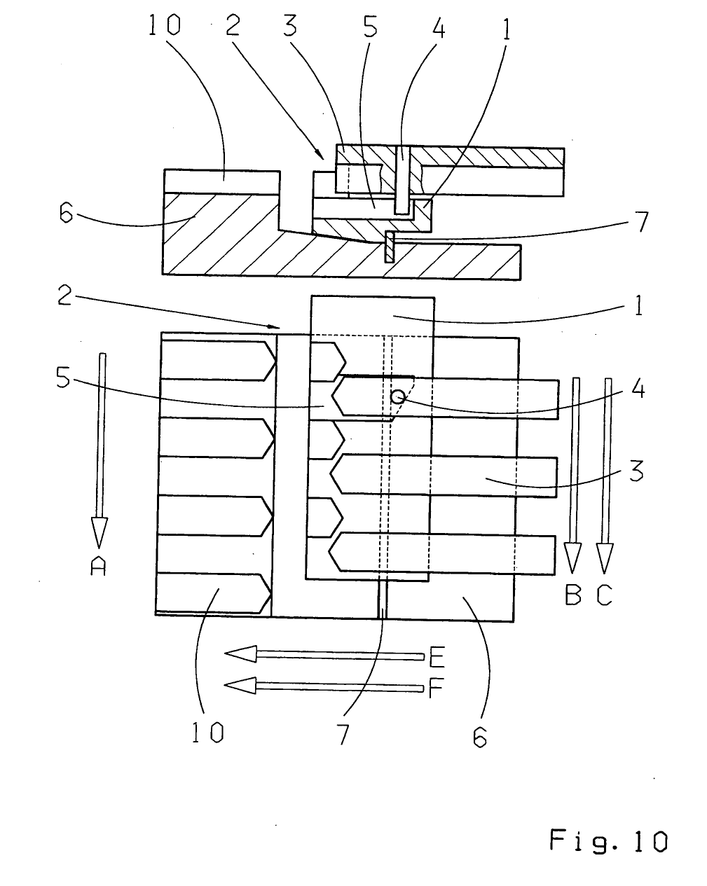

When a disconnection is desired, as shown in FIG. 10, the piston 6 and the synchronizing ring 1, carried along by the end plate which is fixed to the piston, are guided out of the external disc carrier 3 gearing, whereby the guide pin 4 pushes away from a path traveled by the synchronizing ring 1 and against the connecting link 5 and the synchronizing ring 1 is pushed against the end plate 7. Thus, a rotational speed difference develops between the external disc carrier 3 and the synchronizing ring 1, rotating at the same speed, and the piston 6 whereby, according to FIG. 3, the synchronizing ring 1 is rotated via the link guide into the original position by means of the drag moment.

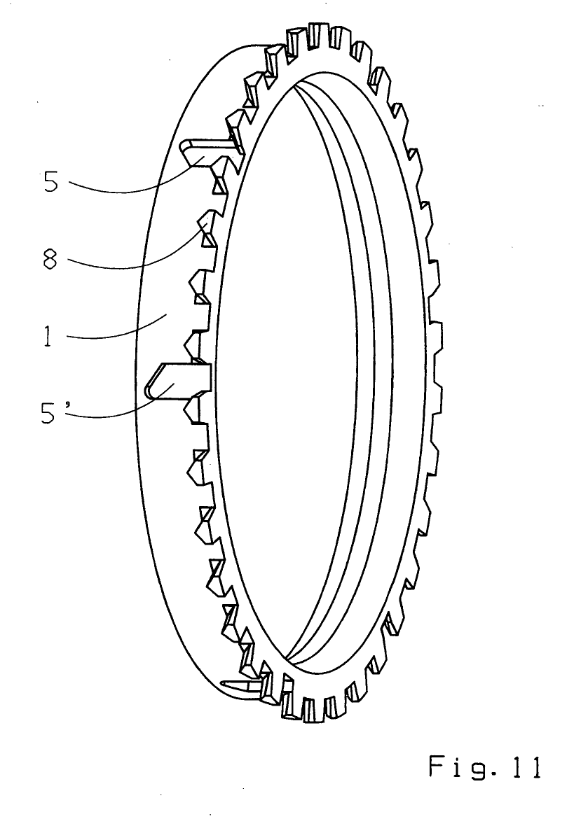

Another advantage of the developed invention is shown in FIG. 11, that it is possible to use a double-sided synchronizing ring 1 which means that it can be applied inversely. For this purpose, connecting links 5, 5′ for a left and a right installation, respectively, are provided in synchronizing ring 1; at least one 5, 5′ link is required per each installation position. According to the invention, the synchronizing ring is not centered via the at least one guide pin 4, but via the external diameter in conjunction with the tip circle diameter of the external disc carrier 3.

Naturally, each constructive design also falls under the protection of the present claims, in particular each spatial arrangement of the components of the form-locking clutch alone and with respect to each other and, if technically feasible, without influencing the form-locking clutch function, even if those designs are not explicitly depicted in the Figures or in the description.

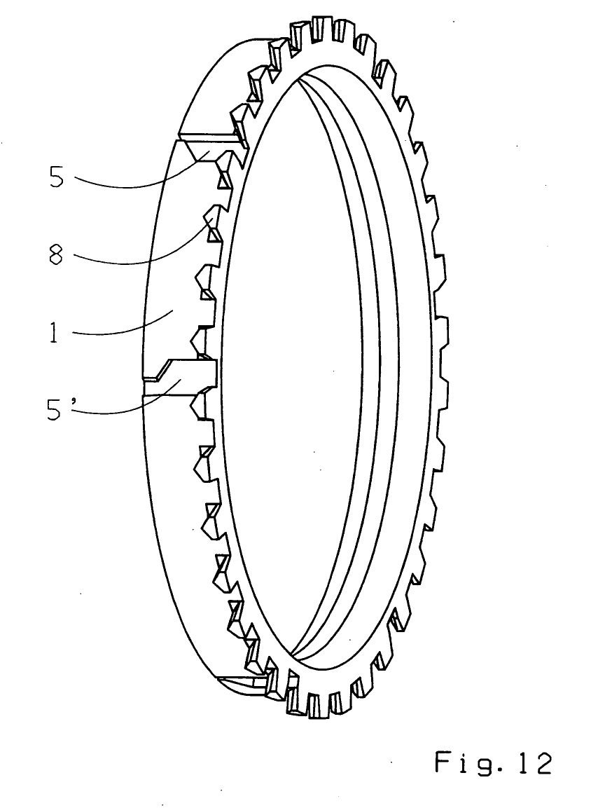

FIG. 12 shows a further embodiment of the synchronizing ring. For easier production of the synchronizing ring, the connecting link 5 can be opened rearward. This does not influence the functionality. This is not relevant in the disengaged state, when the friction areas of the piston and the synchronizing ring touch each other without force.

A further advantage of the synchronizing ring with an open connecting link 5 is a possible shortening of the installation space. The synchronizing ring can be shortened almost by the bar width at the connecting link end.

### REFERENCE NUMERALS

1 synchronizing ring

2 form-locking clutch

3 external disc carrier

4 guide pin

5 connecting link

6 piston

7 end plate

8 synchronizing ring lock gearing

9 external disc carrier lock gearing

10 piston gearing

1-5. (canceled)

6. A form-locking clutch for an automobile transmission in which the form-locking clutch and a disc clutch form a clutch device and in which a piston, one of directly connected to a drive and connected to the drive in a torque proof manner, is connectable to an external disc carrier of the disc clutch via the form-locking clutch which has a synchronizing disc;
wherein at least one guide pin (4) is connected with the external disc carrier (3) of the disc clutch which can move along a connecting link (5) provided on the synchronizing ring (1) of the form-locking clutch in such a way that, with a torque proof connection of the external disc carrier (3) to the piston (6), they can so rotate relative to one another in case of a tooth on tooth position of the components and engage the coupling disc.

7. The form-locking clutch for an automobile transmission according to claim 6, wherein the connecting link (5) is dimensioned such that tooth tips of the lock gearings (8 and 9) of the synchronizing ring (1) and the external disc carrier (3) are so positioned for a deactivated form-locking clutch (2), that the tooth flanks are placed next to each other.

8. The form-locking clutch for an automobile transmission according to claim 6, wherein the synchronizing ring (1) is reverseable whereas links (5, 5′) for a left and a right installation are provided in the synchronizing ring (1) and at least one of links (5, 5′) is required per installation position.

9. The form-locking clutch for an automobile transmission according to claim 6, wherein the synchronizing ring (1) is centered via an external diameter in connection with a tip circle diameter of the external disc carrier (3). +0. The form-locking clutch for an automobile transmission according to claim 6, wherein an end plate (7) supported by on the piston (6) which is positioned below the synchronizing ring (1), when viewed radially, is provided for a side of the synchronizing ring (1) facing away from the piston (6). +1. The form-locking clutch for an automobile transmission according to claim 6, wherein the form-locking clutch is constructed as a coupling disc.
